(19) United States
(12) Patent Application Publication
(10) Pub. No.: US 2014/0058789 A1
(43) Pub. Date: Feb. 27, 2014

(54) PROCESS MODEL GENERATION AND WEAK-SPOT ANALYSIS FROM PLAIN EVENT LOGS

(71) Applicants: MARKUS DOEHRING, Weinheim (DE); Bernhard DRITTLER, Walldorf (DE); Oliver KIESELBACH, Bielefeld (DE); Alexander Christian MUELLER, Mannheim (DE); Birgit ZIMMERMANN, Darmstadt (DE)

(72) Inventors: MARKUS DOEHRING, Weinheim (DE); Bernhard DRITTLER, Walldorf (DE); Oliver KIESELBACH, Bielefeld (DE); Alexander Christian MUELLER, Mannheim (DE); Birgit ZIMMERMANN, Darmstadt (DE)

(21) Appl. No.: 13/593,519

(22) Filed: Aug. 24, 2012

(51) Int. Cl. G06Q 10/06

(52) U.S. Cl. 705/7.27

(57) ABSTRACT

Various embodiments of systems and methods for process model extraction and weak-spot analysis from plain event logs are described herein. In an aspect, the method involves obtaining an event log that includes events grouped by process instances. Based on analyzing the event log a process graph is generated. In another aspect, one or more visual representations of the generated process graph, indicating the weak-spots, are generated. At least one of the one or more visual representations of the process model is rendered in response to receiving a selection of the at least one visual representation. In yet another aspect, the weak-spots are transformed into a data structure and provided as input to a rule mining algorithm for generating a set of rules defining the weak-spots. The set of rules received from the rule mining algorithm are rendered on a graphical user interface (GUI).

### FIELD

The field relates generally to enterprise information systems (EIS). More specifically, the field relates to generating a process model from plain event logs and analyzing weak-spots in the generated process model.

### BACKGROUND

Monitoring and improving business performance is an important area of business management activity. In order to monitor an organization's performance as a whole, business related aspects of the organization are represented as business processes in business process model. The business process model is a model of one or more business processes, and defines the ways in which operations are carried out to accomplish the intended objectives of an organization. Techniques to model business process include flow chart, functional flow block diagram, control flow diagram, Integration definition (IDEF), etc. The business process model typically shows business data and information flow associated with the business processes. By comparing and contrasting the business process model representing the actual performance of a business with a priori process model, the business analysts can define, understand, and validate their business performance.

However the challenge of monitoring and improving business performance in an enterprise information system (EIS), lies in performing business analysis for built-in business process that do not have a priori process models to facilitate analysis. Typically, in an EIS with explicitly modeled process logic, key performance indicators (KPIs) can easily be defined on the process level. Then, the data context attached to the corresponding process instance logs are examined to find patterns which may be reasonably explainable causes for KPI violations. However, in EIS such as a Business Suite, such a layer of explicit process logic is not available as these systems normally run built-in processes. As used herein, built-in refers to the execution of business logic without using an explicit process engine. Rather, the processes evolve according to the actual usage of a system, leading to an individual “implicit process logic” for almost every system operator.

### SUMMARY

Various embodiments of systems and methods for generating a process model from plain event logs and analyzing weak-spots in the generated process model are described herein. In an aspect, the method involves obtaining an event log that includes events grouped by process instances. Based on analyzing the event log a process graph is generated. In a further aspect, weak-spots within the event log are determined based on analyzing statistical information in the event log. In another aspect, one or more visual representations of the generated process graph, indicating the weak-spots, are generated. At least one of the one or more visual representations of the process model is rendered in response to receiving a selection of the at least one visual representation. In yet another aspect, the weak-spots are transformed into a data structure and provided as input to a rule mining algorithm for generating a set of rules defining the weak-spots. The set of rules received from the rule mining algorithm are rendered on a graphical user interface (GUI).

These and other benefits and features of embodiments will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a flow diagram of a method for generating a process model from plain event logs and analyzing weak-spots in the generated process model, according to one embodiment.

FIG. 2 illustrates an exemplary graphical user interface of the process model visualization tool for rendering a customized view of the generated process model, in accordance with an embodiment.

FIG. 3 illustrates an exemplary graphical user interface of the process model visualization tool for rendering a customized view of the generated process model, in accordance with another embodiment.

FIG. 4 illustrates an exemplary input table for a rule mining process, in accordance with an embodiment.

FIG. 5 illustrates an exemplary schematic for automatic weak-spot detection, in accordance with an embodiment.

FIG. 6 is a block diagram of an exemplary system for generating a process model from plain event logs and analyzing weak-spots in the generated process model, according to one embodiment.

FIG. 7 is a block diagram of an exemplary computer system according to one embodiment.

### DETAILED DESCRIPTION

Embodiments of techniques for generating a process model from plain event logs and analyzing weak-spots in the generated process model are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

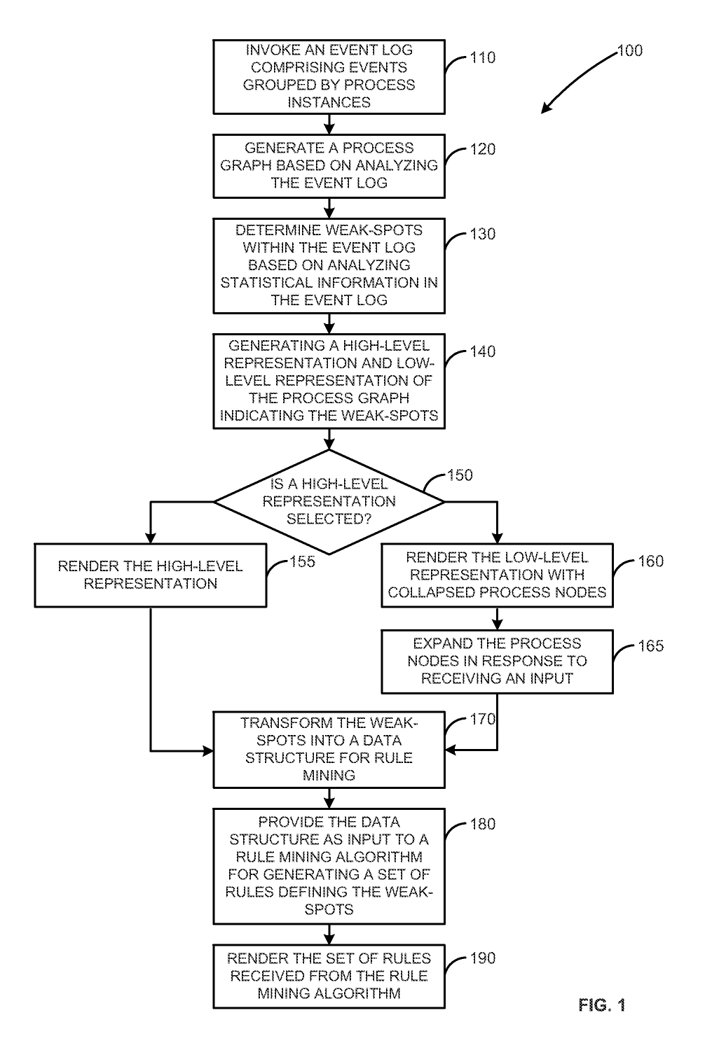

FIG. 1 illustrates a flow diagram of a method 100 for generating a process model from plain event logs and analyzing weak-spots in the generated process model, according to an embodiment. The method 100 is implemented by a computer or any other electronic device having processing capabilities, in an enterprise information system (EIS). In another embodiment, the EIS is an Enterprise Resource Planning (ERP) system having a plurality of business systems which are integrated to each other over a communication network. In an embodiment, the enterprise information system is an on-demand solution in which software and associated data are hosted centrally, e.g., on the Internet and accessed by a computer using a web browser.

The method 100 includes at least the following process illustrated with reference to process blocks 110-190. In an aspect, at block 110, an event log composed of events grouped by process instances is obtained. The term “event log” refers to a chronological record of computer system transactions, called events, which are persisted to a log file on the system. The event log includes meta-data regarding the circumstances under which an entity performed the transactions, including, time stamp, transaction history, originator, event-entity relationship etc. The log file can be reviewed to identify or audit an entity's actions on the system or processes occurring within the system. In an aspect, the transactions are recorded automatically and independently of the entity whose behavior is the subject of the transaction. In an example, the event log is the audit trail of a workflow management system or the transaction logs of an enterprise resource planning system. The event log is structured by grouping a set of identified activities/events under a process instance. The process instance is the subject that undergoes the activities associated with the recorded events. For example, activities such as ‘create purchase order,’ ‘change of line item,’ ‘sign,’ ‘release,’ ‘input of invoice receipt,’ and ‘pay’ may be grouped under a process instance purchase order line item. The event logs can be received from one or more data source systems such as a data warehouse, an integrated ERP system, CRM system, Workflow system, legacy system, external feed, web service, etc. An example XML format similar to a standard-format used in the field of process mining would be:

```
<Process>
    <ProcessInstance id=”1”>
        <ContextData id=”data1”>value1</ContextData>
        <ContextData id=”data2”>value2</ContextData>
    <Event>
        <ContextData id=”data3”>value3</ContextData>
        <type>TypeName</type>
        <timestamp>20111202-1100</timestamp>
    </Event>
    <Event>
        <ContextData id=”data3”>value3</ContextData>
        <type>Type2Name</type>
        <timestamp>20111202-1100</timestamp>
    </Event>
    </ProcessInstance>
    <Process Instance id=”2”>
    ...
<Process>
```

At process block 120, a process graph is generated using a process mining algorithm by analyzing the event log. The process graph represents a sequence of related, structured activities and tasks that serve a particular goal. The process mining algorithm builds the process graph showing process start tasks, process end tasks, successor relations, and various routing constructs such as mutual exclusivity, parallelisms, etc. In an aspect, the process graph is expressed in a visual form, for example, by using Petri Nets or event-driven process chains (EPC). The process graph is followed by nodes representing activities and paths between nodes representing the transition flow between the activities. In an example, time and location stamps in the event logs may be used to determine how a process was undertaken. The data in the “originator” field in the event log may be used to determine which entity was involved in the process. The transaction history and the relationship of entities involved in a particular transaction may be used to determine what happened in the process. Based on the transaction information contained in the event logs, a process model or process graph is deduced to reveal paths within a business process, without a-priori process to guide the process modeling function. In as aspect, the process graph is deduced by applying heuristics to transactions recorded in the event log using which the process graph is built. Applying heuristics to the transactions recorded in the event log yields a prediction of the flow of process that is likely to follow a particular task or process instance. In an aspect, the process graph is generated to include only core process instances by neglecting exceptional behavior within the event log. Such exceptional behavior is detected using statistical data from the event log. For example, the process mining algorithm may neglect low frequency behavior observed from the statistics derived from the event logs.

At process block 130, the process graph is analyzed to determine weak-spots in the process. In an aspect, the weak-spots refer to activities that deviate from a standard order of activities. Since the process model is generated without a-priori process model, the standard order of activities is derived using statistical information extracted from the event log. In an example, the statistical information may be derived from transaction history and optionally by applying heuristics on the transaction history. For example, a standard order of activity may require the activity of placing an order with supplier to be performed upon receiving an approval from the finance team. A weak-spot may be identified if an order is placed before getting the approval. Also, weak-spots encompass deviations in the time taken to perform an activity when compared to an average transaction time for a particular task. The average transaction time may be derived based on analyzing statistical information collected from the event log. In an aspect, the generated process graph is annotated with visual indicators indicating the weak-spots in the process.

At process block 140, a high-level representation and a low-level representation of the process graph is generated. The generated high-level and low-level representations include weak-spot indicators indicating weak-spots in the generated process graph. In an aspect, the high-level representation of the process graph provides a visual indication of frequently used paths and process behavior in the process graph and abstracts the process graph from semantics relating to process nodes and process paths in the process graph. The term “semantics” as used herein refers to specific modeling details such as the relationships between the nodes in the process graph, the routing constructs associated with a node such as parallelisms and mutual exclusivity, synchronization, exclusive choice, and loops.

On the other hand, the low-level representation of the process graph includes semantics information relating to process nodes and process paths in the process graph. For example, the low-level representation shows process transition patterns between the process nodes. In an aspect, the low-level view may not include all paths and exceptional behavior, rather only those paths essential to form an overview of the process behavior are represented, in an aspect, the process transition patterns are illustrated using gateway nodes in the process paths. The gateway nodes clarify the semantics of incoming and outgoing process paths associated with a task.

Since the low-level representation including detailed process information boosts the overall size of the visualized process model, a means for browsing the model in a step-by-step manner is provided. In an aspect, the model is structurally clustered and nodes which are in close proximity to each other are collapsed into groups. The groups constitute coherent segments of the process graph and can be explored step-by-step by expanding the collapsed group.

The high-level representation is rendered on a graphical user interface (GUI) at process block 155 based on determining that a selection for the high-level representation is received at process block 150. The selection for the high-level representation may be provided by a technical domain expert, a process analyst or any other user with limited or no technical background. Alternatively if a selection for a low-level representation is received at process block 150, a low level representation of the process graph is rendered on the GUI. In an aspect, the low-level representation may be initially rendered with collapsed process nodes, at process block 160, and the collapsed nodes may be rendered in expanded mode in response to receiving an input, at process block 165. Irrespective of the visualization type selected, the process graph is rendered on the GUI with visually marked weak-spots assigned to one or more nodes (tasks) or paths (transitions) within the process graph. The visually marked weak-spots are rendered selectable for further analysis. For example, a user may select a weak-spot for further analysis by simply clicking the weak-spot using an input means such as a mouse click. Alternatively, the weak-spot may he selected for analysis by simply hovering a cursor over the weak-spot in the process graph rendered on the GUI.

At process block 170, the selected one or more weak-spots are subject to further analysis by transforming the selected weak-spots into a tabular data structure suitable for rule mining. In an aspect, the tabular data structure is generated by creating a data variable column for each data context variable and a target class column for each selected weak-spot. In an aspect, the target class column receives binary values to indicate whether a weak-spot has occurred in a process instance or not, the process instance defined by a combination of the data context variables. For each process instance in the event log, a row in the tabular data structure is filled with actual data context values and the target class column is filled with information regarding the presence or absence of a weak-spot.

At process block 180, the generated tabular data structure is provided as input to a rule mining algorithm such as C5.0 or Fuzzy Unordered Rule Induction Algorithm (FURIA) or any other rule mining algorithm that provides unordered rules for the weak-spots, i.e., rules which can be interpreted each for its own independent of others. The set of rules generated by the rule mining algorithm is then rendered on the GUI, at process block 190.

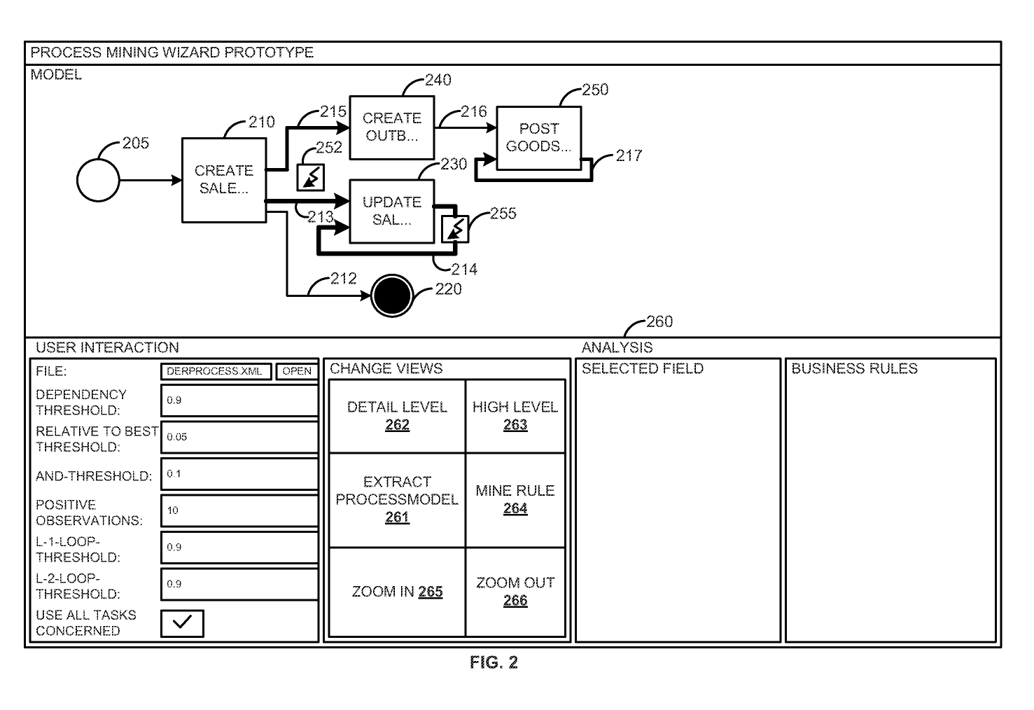

FIG. 2 illustrates an exemplary graphical user interface of the process model visualization tool. As shown, a customized view of the generated process model is rendered on a GUI of a computing system. The customized view is a high-level representation 200 of the process model is rendered on the GUI. The GUI further includes a dashboard 260 providing options for user to manipulate the process model. The options in the dashboard include an option 261 to extract the process model, options 262 and 263 to select a high-level view or a low-level view of the process model, an option 264 to execute rule mining, and options 265 and 266 to zoom-in or zoom-out the rendered process model. In the given example, the process model is extracted from event logs associated with a sales order processing instance. The process model includes nodes representing tasks start task 205, “create sales order” 210, “create outbound delivery” 240, “post goods receipt” 250, and “update sales order” 230 for the sales order processing instance. Further, the paths between the nodes are represented by lines 212 to 217 starting out from or coming in to a node 210, 220, 230, 240, or 250. In the given example, the lines 212 to 217 are rendered with varying boldness in order to represent a probability that a specific task would follow another task in the process flow. For example, the varying boldness of the lines 213 and 215 from the ‘create sales order’ node 210 to the ‘update sales order’ node 230 and ‘create outbound delivery’ node 240 respectively indicates that it is more probable that an ‘update sales order’ task 230 follows the ‘sales order creation’ task 210 than the ‘create outbound delivery’ task 240 following the ‘create sales order task’ 210.

Further, as shown in the figure, the process model includes visually marked weak-spots 252 and 255. In the given example, the path between the nodes ‘create sales order’ 210 and ‘update sales order’ 230 and the looping path associated with the ‘update sales order’ node 230 are indicated as weak-spots. The paths are marked as weak-spots to indicate a high transition time between the tasks ‘create sales order’ and ‘update sales order.’ For example, the transition time between the tasks may be detected as a deviation based on applying heuristics to the event log.

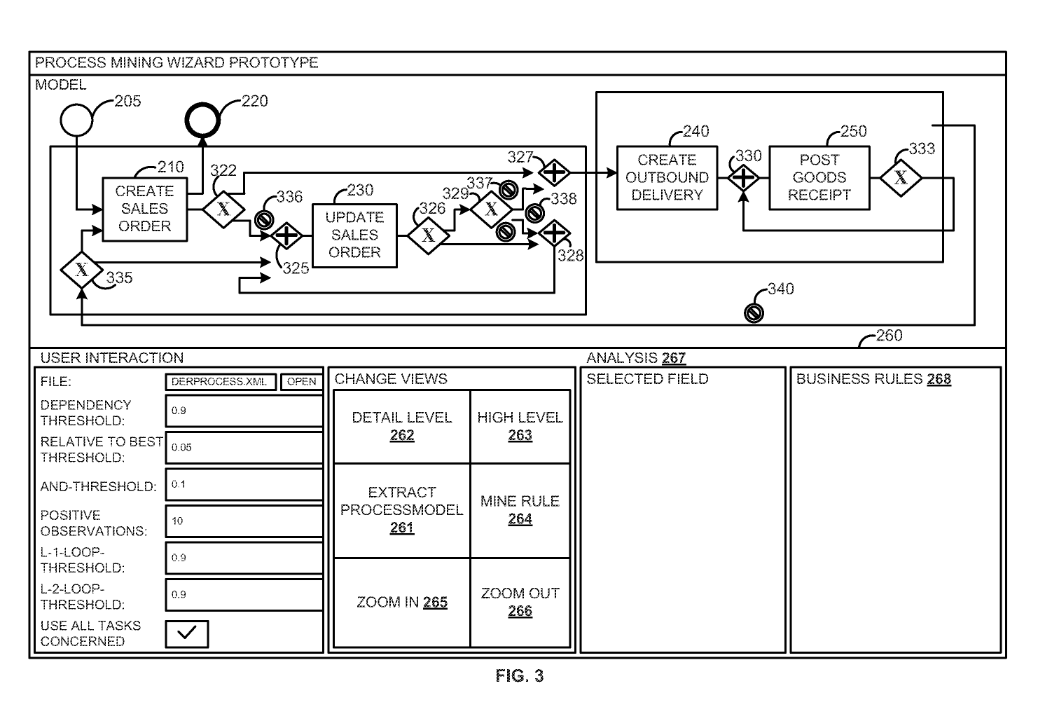

In an embodiment, upon selecting the option for viewing a low-level representation, the process model visualization tool renders the low-level representation 300 of the process model on the GUI as shown in FIG. 3. The low-level representation 300 shows an expanded view of the process model including nodes and paths rendered at a granular level. The low-level view 300 shows various routing constructs associated with the nodes such as mutual exclusivity, parallelism, loops, synchronization, and exclusive choice. Also, the low-level representation 300 includes gateway nodes 322, 325, 326, 327, 328, 329, 330, 333, and 335 to clarify the semantics of the incoming and outgoing process paths of a node. Further, the low-level representation 300 of the process model includes weak-spots 336 to 340 marked at the granular level. In the given example, it is shown that after the ‘create sales order’ task 210 is executed, the process may terminate at 220 or proceed to a XOR-split connector 322 that has multiple outgoing paths but only one path will be processed. From the connector 322, the process may proceed to AND-join connector 325 if the path 323 is processed. At AND-join connector 325, the process waits until any parallel control flows that have been started are finished. The process then proceeds to execute the ‘update sales order’ task 230. Following the “update sales order’ task 230 execution, the process proceed to XOR-split connector 326 where only one path will be processed. In the given example, at XOR-split connector 326, the process proceeds to either AND-join connector 328 or XOR-split connector 329. Alternatively, if the path 324 is processed at 322, the process proceeds to XOR-join connector 327 which waits for the completion of control flow in the selected path. From 327, the process may proceed to execute ‘create outbound delivery’ task 240. Upon executing the ‘create outbound delivery’ task 240, the process proceeds to execute ‘post goods receipt’ task 250 via AND-join connector 330. The AND-join connector 330 also receives a recurring path from the ‘post goods receipt’ task 250 via XOR-split connector 333. From the XOR-split connector 333, the process may loop back to either the ‘create sales order’ task 210 or the AND-join connector 325 via XOR-split connector 335.

Irrespective of the type of view selected, the weak-spots 336 to 340 rendered in the visual representation of the process model are selectable from the GUI using any input means including hut not limited to mouse, keypad, keyboard, and touch display. In an aspect, upon selecting a weak-spot 336 to 339 or 340, an analysis 267 of the weak spot is presented and a rule-mining algorithm is triggered to discover business rules defining the weak-spots. The discovered business rules 268 are rendered on the GUI as part of the dashboard 260. The rules generated by the rule mining algorithm embody “explanations” for the weak-spots 336 to 339 and/or 340. In an example, based on the rule set the most characteristic data values of all the data values within the process instance logs, that are potentially “causing” the weak spot are identified and displayed to the user.

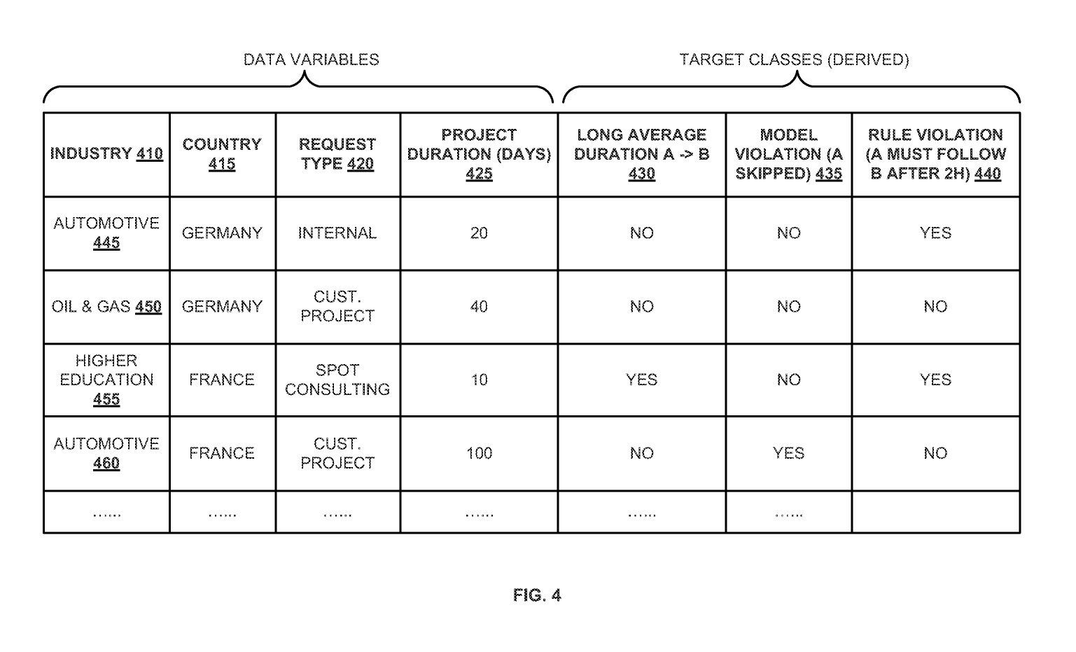

FIG. 4 illustrates an exemplary input table for rule mining, in accordance with an embodiment. In an aspect, the rule mining process is executed using a rule mining algorithm such as C5.0. The rule mining algorithm is triggered in response to a selection of one or more weak-spots rendered in the process graph. The “weak-spots” in terms of “irregularities” within the logs are determined based on an optional combination of:
Examining time relations (e.g., task transitions taking extraordinarily long on average).
Violations of the automatically discovered process models (e.g. a process suddenly ends in the middle)
Violations of arbitrary constraints on the log events, (e.g. violation of a process constraint requiring a minimum delay of 2 h before the repeated execution of a task.
   In certain scenarios it is clear where in the process model a weak spot is mapped (e.g., transition times), in other scenarios (e.g., when multiple task nodes are involved when a constraint is violated) additional mapping mechanisms are invoked, such as mapping a weak spot to the last task which “triggers” the constraint violation.

Upon selecting one or more weak-spots for further analysis, a tabular data structure 400 suitable for rule mining is internally generated as illustrated in FIG. 4. The tabular data structure includes fields 410, 415, 420, and 425 representing one or more data variable columns. The data variable columns are created for each data context variable that is assigned to process instances in the event log. Further the tabular data structure includes fields 430, 435, and 440 representing one or more target class columns corresponding to one or more weak-spots detected in the process model. In the simplest cases, the target class columns receive binary values that indicate whether a weak spot has occurred in a process instance for a particular combination of data variables or not. For each process instance in the event log, a row 445, 450, 455, or 460 in the tabular data structure is filled with actual data context values and a row in the target class column is filled with information regarding the presence or absence of a weak-spot, in the given example, a tabular data structure is created for rule mining including data variable fields such as ‘industry’ 410, ‘country’ 415, ‘request type’ 420, and ‘project duration’ 425. Further, the tabular structure includes target class columns 430, 435, and 440 for weak-spots including 1) time deviation, e.g., long average duration from task A to task B, 2) model violation e.g., skipped process A, and 3) rule violation, e.g., task A must follow task B after two hours.

The rows 445, 450, 455, or 460 under each of the data variable field are populated with actual data context values as recorded in the process instance logs. Also the rows 445, 450, 455, or 460 under the target class fields indicate the presence or absence of a corresponding weak-spot. In an example, referring to row 445, it may be derived from a process log, that for an automotive industry in Germany, the project duration for an internal request type is 20 days and has an associated weak-spot in the process execution, in that, a rule that task A mast follow task B after two hours is violated. The generated data structure is provided as input to a rule mining algorithm such as C5.0⁴ or Fuzzy Unordered Rule Induction Algorithm (FURIA) to deliver unordered rules for the weak spots, i.e. rules which can be interpreted each for its own without knowing the others. For example, the generated rules predict for which combination of data variables, the weak-spot occurs or does not occur. The mined rules can then be utilized to alter the information system to prevent problematic process instances by counteracting (only) in specific data contexts.

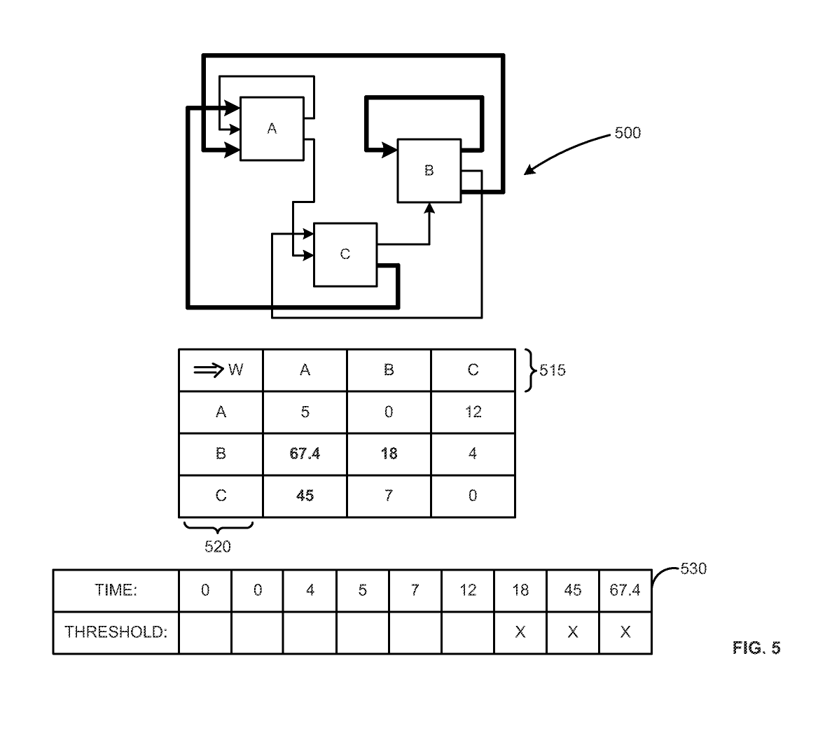

FIG. 5 illustrates an exemplary process for automatic weak-spot detection, in accordance with an embodiment. The example shown in FIG. 5 includes an exemplary process graph 500 with nodes representing tasks A, B, and C and paths representing transition between the nodes. A table 510 is generated with the nodes of the process graph 500 forming the header column 515 and header row 520 fields. The table 510 is filled with values representing the transition time between the nodes A, B, and C. The values representing the transition times are analyzed and the worst ‘X’ percentage (whereas ‘X’ can be chosen by the business analyst) of the transition times are marked as weak spots. In the given example, the transition times of 18, 45, and 67.4 in the table 530 represented by bolded paths in graph 500 are identified as the worst 25% of the transition times. Other criterion for marking a threshold for measuring weak-spots is well within the scope of this embodiment.

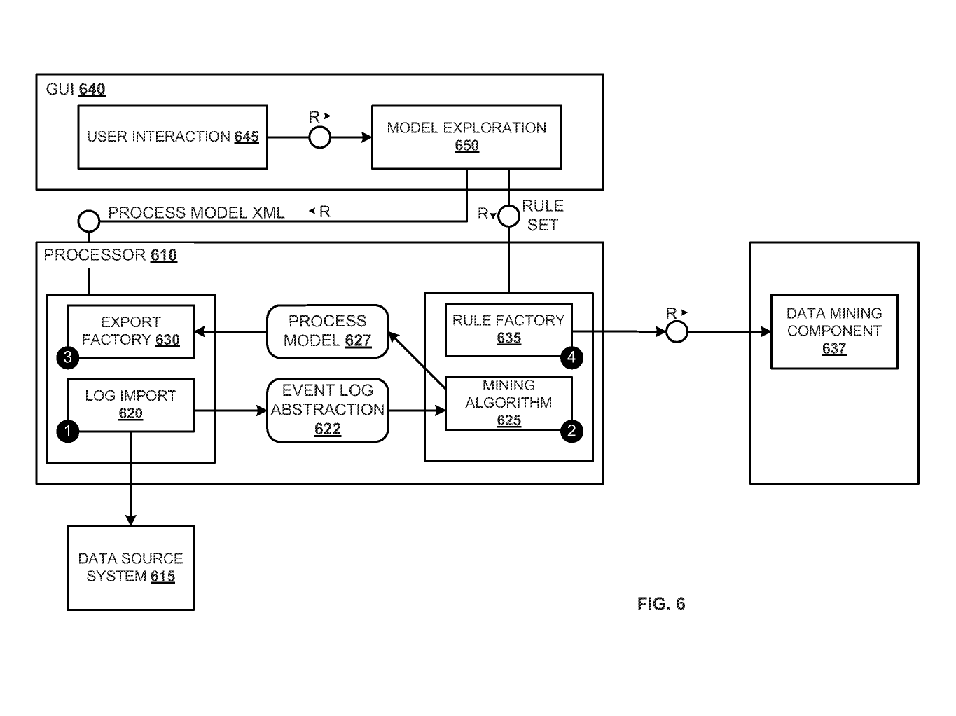

FIG. 6 is a block diagram 600 of an exemplary information system for generating a process model from plain event logs and analyzing weak-spots in the generated process model, according to one embodiment. The information system includes a processor 610 communicatively coupled to data source systems. The processor 610 includes computer readable instructions 620 for importing the event logs from the data source systems 615, mining algorithm 625 for generating a process model based on the imported event logs, and instructions 630 for exporting the generated process model to a graphical user interface (GUI) 640. Further, the processor 610 includes a rule factory 635 comprising computer readable instructions for transforming the event logs into appropriate data structure for mining by a rule mining algorithm. The generated data structure is then provided as an input set to the rule mining algorithm implemented by data mining components 637 such as a business objects (BOBJ) predictive workbench. The rule mining algorithm generates a set of rules defining the weak-spots that are classified in the data structure. The generated ruleset is then provided to the rule factory 635. The rule factory 635 provides the ruleset to the GUI 640 for displaying alongside the process model in response to a selection of the corresponding weak-spot.

Further, the graphical user interface (GUI) 640 includes an interface for user interaction 645 and an interface for model exploration 650. The model exploration interface 650 enables the navigation of the process model that is rendered on the GUI 640. For example, the model exploration interface 650 enables a user to select one or more options including selecting a view (low-level/high-level) of the process mode, selecting a weak-spot, performing rule mining, etc. The user interaction interface 645 enables a user to set threshold values related to events in the process model.

Examples of the data source systems 615 include a data warehouse, an integrated ERP system, CRM system, workflow system, legacy system, external feed, and web service, and MXML event log file. In an embodiment, a business suite transfers its events into a data structure and provides it to the log import module 620. The log import module 620 abstracts (622) the event log and provides the abstracted event logs to the mining algorithm 625 for model generation (627). The process model generated by the mining algorithm 625 is provided to the export factory 630 for rendering on the GUI 640. The event log abstracted at 622 is also provided to the rule factory 635 for transforming the data context variables and weak-spots detected in the event logs into a data format for rule mining. The data structure is then provided to an appropriate rule mining algorithm, in this example implemented by a BOBJ predictive workbench 637. The ruleset from the rule mining algorithm is received by the rule factory 635 and provided to the GUI 640 for display, in an aspect, the analysis of the event log and the production of rule set are initiated in response to receiving a selection of one or more weak-spot in the process models that is rendered on the GUI 640. For example when a weak spot indicated in the process model is selected, a request for the rules defining the weak-spot is sent to the processor 610, where the input data structure for the rule mining algorithm is generated by the rule factory and provided to the rule mining algorithm 625. The ruleset generated by the rule mining algorithm is received by the rule factory 635 and sent back to the GUI 640 where the ruleset is displayed.

Therefore this work aims at enabling a model-driven analysis layer also for built-in business processes, requiring only correlated process instance logs and no further a-priori knowledge on the process behavior. The innovation of the method presented here consists in utilizing suitable chaining and data milliner components to presuppose a minimal amount of user intervention, making it a wizard-like or guided approach to quickly get from a plain event log, an overall overview of the “main” process behavior with individual weak-spots and their explanations.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

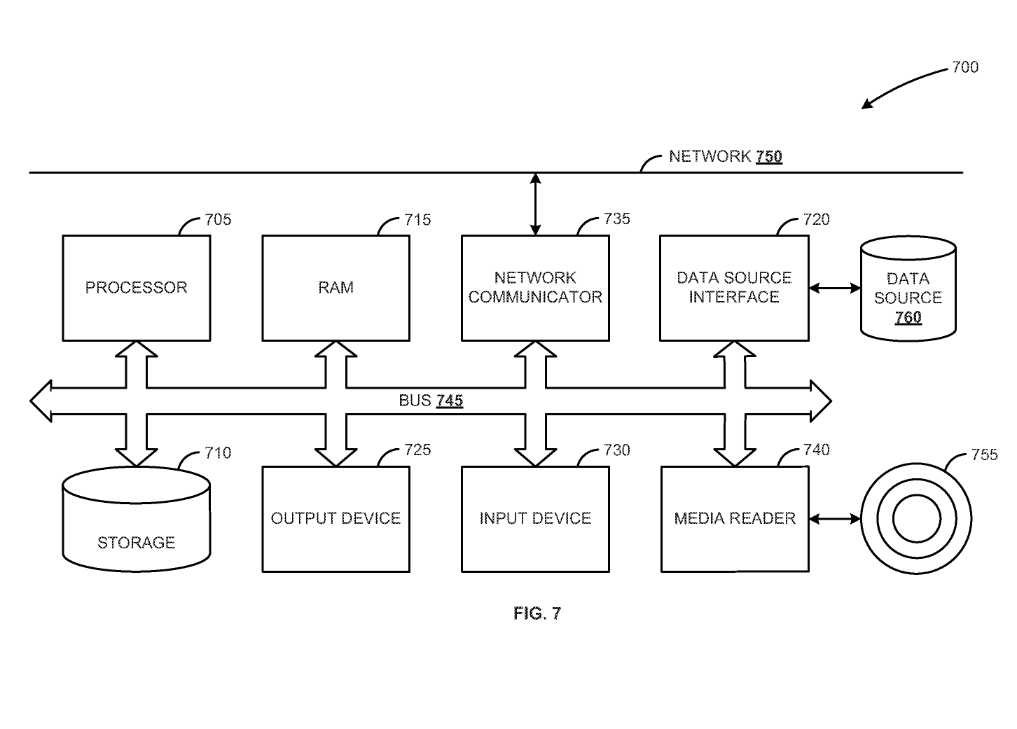

FIG. 7 is a block diagram of an exemplary computer system 700. The computer system 700 includes a processor 705 that executes software instructions or code stored on a computer readable storage medium 755 to perform the above-illustrated methods. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 650 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as sonic steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

1. A computer-implemented method for representing a business process behavior, the method comprising:
obtaining an event log, wherein the event log comprises records of events grouped by process instances, wherein the events represent related activities;
generating a process graph to visually represent a sequence of the events in the event log;
identifying weak-spots in the generated process graph using statistical information pertaining to the sequence of events in the process graph;
visually representing the identified weak-spots in the process graph;
transforming, by a computer, the weak-spots into a data structure for rule mining;
providing the data structure as input to a rule mining algorithm for generating a set of rules defining the weak-spots; and
rendering the set of rules received from the rule mining algorithm.

2. The method of claim 1, wherein generating the process graph comprises generating a high-level representation and a low-level representation of the process graph.

3. The method of claim 2, wherein generating the high-level representation of the process graph comprises abstracting the process graph from semantics relating to process nodes and process paths that form the process graph.

4. The method of claim 2, wherein generating the high-level representation of the process graph comprises providing a visual indication of frequently used paths between nodes in the process graph.

5. The method of claim 2, wherein generating the low-level representation of the process graph comprises showing, in the process graph, semantics information relating to process nodes and process paths that form the process graph.

6. The method of claim 5, wherein showing semantics information in the process graph comprises showing process transition patterns between the process nodes, wherein the process transition patterns are defined by gateway nodes in the process paths.

7. The method of claim 1, wherein generating the process graph to visually represent the events in the event log further comprises generating the process graph comprising core process instances.

8. The method of claim 7, wherein generating the process graph comprising core process instances comprises neglecting exceptional behavior within the event log using statistical data extracted from the event log.

9. The method of claim 1, wherein generating the process graph to visually represent the events in the event log comprises deducing the process graph by applying heuristics to events recorded in the event log.

10. The method of claim 1, wherein transforming the weak-spots into the data structure for rule mining comprises generating a tabular data structure comprising data variables and target classes defining the weak-spots.

11. The method of claim 1, wherein determining weak-spots within the event log comprises determining irregularities within the process graph using a reference process, wherein the reference process is derived using the statistical information.

12. The method of claim 11, wherein the weak-spots are identified as irregularities in task transition times, violation of automatically discovered process models, and violation of arbitrary constraints.

13. The method of claim 1, wherein rendering the set of rules received from the rule mining algorithm comprises rendering the set of rules within the process graph on a graphical user interface (GUI).

14. An article of manufacture, comprising:
a non-transitory computer readable storage medium having instructions which when executed by a computer causes the computer to:
obtain an event log, wherein the event log comprises records of events grouped by process instances, wherein the events represent related activities;
generate a process graph to visually represent a sequence of the events in the event log;
identify weak-spots in the generated process graph using statistical information pertaining to the sequence of events in the process graph;
visually represent the identified weak-spots in the process graph;
render a high-level representation of the process graph indicating the weak-spots;
transform the weak-spots into a data structure for rule mining;
provide the data structure as input to a rule mining algorithm for generating a set of rules defining the weak-spots; and
receive a selection for at least one weak-spot in the generated visual representation of the process model;
render one or more rules received from the rule mining algorithm, wherein the one or more rules pertain to the selected weak-spot.

15. The article of manufacture in claim 14, wherein the instructions further cause the computer to render a low-level representation of the process graph indicating the weak-spots, in response to receiving a selection via a GUI.

16. A device comprising:
a graphical user interface (GUI);
a memory to store a program code; and
a processor to execute the program code to:
obtain an event log from the memory, wherein the event log comprises records of events grouped by process instances, wherein the events represent related activities;
generate a process graph to visually represent a sequence of the events in the event log;
identify weak-spots in the generated process graph using statistical information pertaining to the sequence of events in the process graph;
visually represent the identified weak-spots in the process graph;
transform the weak-spots into a data structure for rule mining;
provide the data structure as input to a rule mining algorithm for generating a set of rules defining the weak-spots; and
render the set of rules received from the rule mining algorithm on the GUI.

17. The device of claim 16, wherein the generated process graph comprises nodes and paths connecting the nodes.

18. The device of claim 17, wherein the nodes represent process tasks and the paths represent the process transition between the nodes.

19. A system operating in a communication network, comprising:
at least one source system; and
a computer comprising a memory to store a program code, a graphical user interface (GUI), and a processor to execute the program code to:
obtain an event log from the memory, wherein the event log comprises records of events grouped by process instances;
generate a process graph to visually represent a sequence of the events in the event log;
identify weak-spots in the generated process graph using statistical information pertaining to the sequence of events in the process graph;
visually represent the identified weak-spots in the process graph;
transform the weak-spots into a data structure for rule mining;
provide the data structure as input to a rule mining algorithm for generating a set of rules defining the weak-spots; and
render the set of rules received from the rule mining algorithm on the GUI.

20. The system of claim 19, wherein the at least one data source system includes at least one of, a data warehouse, an integrated ERP system, CRM system, Workflow system, legacy system, external feed, and web service.
